(19) United States
(12) Patent Application Publication
(10) Pub. No.: US 2008/0123739 A1
(43) Pub. Date: May 29, 2008

(54) Wireless Transmission of High Quality Video

(75) Inventors: Zvi Reznic, Tel-Aviv (IL); Noam Geri, Los Altos, CA (US)

Correspondence Address: PRTSI, P.O. Box 16446, Arlington, VA, 22215, US

(73) Assignee: AMIMON LTD., HERZELIA (IL)

(21) Appl. No.: 10/574,023

(22) PCT Filed: Aug. 26, 2004
(86) PCT No.: PCT/IL04/00779

§ 371 Date: Jan. 17, 2007

Related U.S. Application Data
(60) Provisional application No. 60/505,439, filed on Sep. 25, 2003.
(60) Provisional application No. 60/508,061, filed on Oct. 2, 2003.
(60) Provisional application No. 60/590,197, filed on Jul. 21, 2004.

(51) Int. Cl. H04N 7/26

(52) U.S. Cl. 375/240.08; 375/347; 375/E07.076

(57) ABSTRACT

A method of transmitting video images. The method includes providing a high definition video stream, compressing the video stream using an image domain compression method, in which each pixel is coded based on a vicinity of the pixel and transmitting the compressed video stream over a fading transmission channel.

### RELATED APPLICATIONS

The present application claims the benefit under 35 USC 119 (e) of U.S. Provisional Applications No. 60/505,439 filed Sep. 25, 2003, 60/508,061 filed Oct. 2, 2003 and 60/590,197 filed Jul. 21, 2004, the disclosures of which are incorporated by reference.

### FIELD OF THE INVENTION

The present invention relates generally to wireless transmission of high quality still and/or video images and particularly to high quality wireless transmission of images in relatively noisy and/or fading environments.

### BACKGROUND OF THE INVENTION

In many houses, television and/or video signals are received through cable or satellite links at a set-top box at a fixed point in the house. In many cases it is desired to place a screen at a point distanced from the set-top box by a few meters. Connection of the screen to the set-top box through cables is generally undesired for aesthetic reasons and/or installation convenience and wireless transmission of the video signals from the set-top box to the screen is preferred. Similarly, it may be desired to place a computer, game controller, VCR, DVD or other video source that generates images to be displayed on a screen distanced from the screen.

Generally, the data is received at the set-top box in a compressed MPEG format and is decompressed by the set-top box to a high quality raw video signal. The raw video signal may be in an analog format or a digital format, such as the digital video interface DVI format or the high definition multimedia interface (HDMI) format. These digital formats generally have a high definition television (HDTV) data rate of up to about 1.5 Giga bits per second (Gbps). One available spectrum for short range transmission of video images in the United States is 5.15-5.85 GHz.

Therefore, the video generally needs to be recompressed for wireless transmission. Known strong video compression methods (e.g., having a compression factor of above 1:30) require very complex hardware for implementing the compression, which is not practical for home apparatus. These compression methods generally transform the image into a different domain (e.g., using wavelet, DCT or Fourier transforms) and performing the compression in that domain. Alternatively or additionally, strong video compression methods have a relatively high image degradation, which is unacceptable for high quality video display. The known strong video compression methods also suffer from high sensitivity to transient noise and fading, such that an entire frame or even more may be lost due to a short fading period.

It has been suggested to wirelessly transmit the compressed MPEG format signals received by the set-top box, before decompression and decryption, directly to the screen, where they are decompressed. One reason that this is not implemented is that the content providers do not want to provide the decryption keys to producers of the wireless transmission equipment.

Known high rate and high quality video compression methods, on the other hand, do not sufficiently compress the video signals to allow their practical transmission on the available bandwidth with an acceptable safety margin protection from noise and fading. Using a small safety margin requires a retransmission mechanism with a large buffer, which also increases the cost of the transmission apparatus.

U.S. Pat. No. 5,768,535 to Chaddha, et al., the disclosure of which is incorporated herein by reference, describes a video compression method in which an image is repeatedly down-scaled a plurality of times and error images describing the differences between the down-scaled images are generated. This method does not substantially save bandwidth, but rather allows adaptation to available cable bandwidth. In addition, this method allows viewing low quality images when the noise level is relatively high. However, in a wireless environment, the proportion of time in which low quality images would be displayed is unacceptable.

U.S. patent publication 2003/002582 to Obrador, the disclosure of which is incorporated herein by reference, describes wireless transmission of images which are encoded using joint source channel coding (JSCC). The transmitted images are decomposed into a plurality of sub-bands of different frequencies. Image and corresponding boundary coefficients with a lowest resolution are sent first and then image and boundary coefficients with a higher resolution are transmitted. An exemplary JSCC applies channel encoding techniques to the source coded coefficients, providing more protection to more important, i.e., low frequency, coefficients and less protection to less important, i.e., high frequency, coefficients.

In digital transmission methods, signals are transmitted in the form of symbols. Each symbol can have one of a predetermined number of possible values. The set of possible values of each symbol is referred to as a constellation and each possible value is referred to as a bin. In two dimensional constellations, the distance between neighboring bins affects the immunity of the symbols to noise. The noise causes the symbol to be received not exactly in the intended bin. If, due to the noise, the symbol is closer to a different bin than intended, the symbol may be interpreted incorrectly.

An article titled “Advanced Television Systems for Terrestrial Broadcasting: Some Problems and Some Proposed Solutions”, by William F. Schreiber, proceedings of the IEEE, Vol. 83, No. 6, June 1995, suggests a method of transmission in which video signals are divided into a low level image, a second level image and a third level image. The second level image is a low level portion of the difference between the original image and the low level image, and, similarly, the third level image is the difference between the original image and the combination of the low level image and the second level image. Each of the low level, second level and third level images is transformed and the resultant coefficients are encoded. The low level image is transmitted on a digital constellation and the coefficients of the second and third level images are represented by analog signals superimposed on the digital symbols. In the decoding process of a received symbol, the original bin of the symbol is determined and then the analog value is determined.

An article by U. Mittal and N. Phamdo entitled “Hybrid digital-analog (HDA) joint source-channel codes for broadcasting and robust communication”, the disclosure of which is incorporated herein by reference, was published in IEEE Transactions on Information Theory on May 2002. This article summarizes results in U. Mittal's Ph.D. thesis from State University of New-York at Stony Brook, August 1999, entitled “Broadcasting, robustness and duality in a joint source-channel coding system”. This work suggested several theoretical schemes for sending analog sources over unknown channels or broadcast channels including a system, which sends a superposition of a coarse portion and a refinement portion.

Further discussion of systems as in this article, for cases in which the refinement portion is small enough to have a Gaussian distribution, has been analyzed in a paper summary of Z. Reznic and R. Zamir, entitled “On the Transmission of Analog Sources over Channels with Unknown SNR”, presented at the International Symposium on Information Theory, July 2002, Lausanne, and in a Ph.D. thesis of Z. Reznic at Tel-Aviv University, entitled “Broadcasting Analog Sources over Gaussian Channels”. These articles and theses focus on analyzing the previously known concepts of transmission of coarse and refinement data.

The disclosures of all of the above articles and theses are expressly incorporated herein by reference.

### SUMMARY OF THE INVENTION

An aspect of some embodiments of the invention relates to transmission of high definition video compressed in an image domain, i.e., the compression does not involve a transform to a different domain (e.g., using DCT, wavelet or Fourier transforms). In some embodiments of the invention, in the image domain, the image is represented by color values of pixels. Optionally, the compression does not directly link more than a small vicinity of pixels (e.g., having a diameter of up to 20 pixels, or even 10 pixels) together, such that errors in a given pixel do not propagate at all or the errors fade as they propagate. In some embodiments of the invention, at least some of the pixels are encoded without relation to other pixels. These pixels are optionally used as a base for encoding other pixels, such that the effect of an error in one pixel fades quickly. Not using a transform in the compression may simplify the compression and make the compression cheaper.

Alternatively or additionally, the compression does not link between pixels of different frames. Using an image domain compression, although requiring a relatively large bandwidth for transmission, is more efficient, since it is less susceptible to noise and fading.

In some embodiments of the invention, the transmission is performed on a fading channel, on which the noise conditions change substantially over time. For example, the transmission may be performed over a wireless link, optionally a short range (e.g., up to 10-20 meters) link.

It is noted that the advantages of using an image domain compression and particularly an image domain compression which uses local areas of pixels may be exploited also when applied to only one or more layers of an image. For example, an image may be divided into a low quality layer and one or more correction layers. One or more of the layers are optionally compressed in the image domain, while other layers are compressed using other compression methods or are not compressed at all.

An aspect of some embodiments of the invention relates to dividing transmitted video signals into a coarse portion, which is a low level representation of the video images, and a refinement portion, which represents a difference between the video images and the coarse portion. The division of the video signals into coarse and refinement portions is performed such that the refinement portion for each pixel, for at least one of the color components of the image, is bounded within a predetermined range of values. The refinement portion is transmitted superimposed on an encoding of the coarse portion.

Having the refinement portion bounded for each pixel, puts a limit on the error which may be caused by loss of the refinement portion at any pixel of the image. In contrast, in the prior art, some pixels may have very large errors which will generally be noticed by the viewer and may be uncomfortable to the viewer's eye.

Bounding the refinement portion values also makes the transmission of the refinement portion simpler. Optionally, the number of bins in a constellation used for representing the refinement portion is adjusted according to the bounded value of the refinement portion. Thus, the number of symbols used for each predetermined number of pixels can be predetermined.

In some embodiments of the invention, the refinement portion is superimposed on the coarse portion in a manner which uses only a portion of a noise safety margin of the coarse portion on the communication link, so that the refinement portion does not substantially interfere with the decoding of the coarse portion. The safety margin refers herein to the difference between the average signal to noise ratio (SNR) required for the transmission of the data of the coarse portion and the average effective SNR of the link. In some embodiments of the invention, the refinement portion leaves at least 5-10 dB, at least 15 dB or even 20-25 dB of the safety margin for the coarse portion.

The refinement portion optionally uses between about 3-7 dB, although greater or smaller power levels and/or signal to noise ratios (SNRs) may be used. Optionally, the refinement portion uses between about 25-40% (in dB) of the safety margin of the link. Alternatively, for example when the safety margin is relatively large (e.g., above 30 dB), the refinement portion uses more than 40% of the safety margin. Further alternatively, for example when the safety margin is relatively small, the refinement portion uses a smaller percentage of the safety margin (e.g., between about 10-20%), so that enough margin is left to ensure proper reception of the coarse portion even under unfavorable conditions.

When there are low noise levels, the refinement portion will be decodable in its entirety by the receiver. For high noise levels, the refinement portion will not be decodable in its entirely, but the coarse signal will nearly always be useable in its entirety.

The refinement portion is optionally encoded digitally using a constellation which takes into account the possible discrete values of the refinement portion for each pixel. Alternatively, the refinement portion is encoded using a continuous (analog) constellation.

In some embodiments of the invention, the coarse portion includes different sub-portions that have different protection, so that more important sub-portions of the coarse portion have a higher effective safety margin. Optionally, a super-position code (i.e., a broadcast code) is used for the coarse portion, assigning constellation points with a larger safety margin to more important sub-portions. Alternatively or additionally, the more important sub-portions of the coarse portion are protected with a stronger FEC.

In some embodiments of the invention, the coarse portion is generated by a lossy compression of the video signals. Optionally, the refinement portion represents the data lost from the video signals in converting them into the coarse portion. Alternatively, the refinement portion includes some of the data lost in the compression, while some (e.g., more important) parts of the data lost in the compression are included in the coarse portion (e.g., are encoded into bits which are interleaved with the coarse portion). In some embodiments of the invention, the coarse and refinement portions together (before transmission) represent the original video images without loss. Alternatively or additionally, the coarse and refinement portions together represent the video images in a standard representation of color video with slight filtering, such as sub-sampling of the chromo components (e.g., 4:2:2, 4:2:0 4:1:1). Further alternatively, the coarse and refinement portions together represent a lossy version of the original image.

In some embodiments of the invention, the refinement portion is added in a plurality of levels, each level having a constellation which does not substantially interfere with detecting the previous level.

In some embodiments of the invention, the transmission is performed with multi-input-multi-output (MIMO) modulation, using a plurality of transmitters and receivers. Using MIMO modulation allows adding the refinement portion to the signal of each of the transmitters, thus increasing the amount of data which can be included in the refinement portion, and consequently the quality of the video signals received.

An aspect of some embodiments of the invention relates to dividing transmitted video signals into a coarse portion, which is a low level representation of the video images, and a refinement portion, which represents a difference between the video images and the coarse portion. The values of the refinement portion are transmitted uncompressed. In some embodiments of the invention, values of the refinement portion are transmitted without error correction coding. Alternatively or additionally, the values of the refinement portion are transmitted as values in the image domain, such as error values for image locations (e.g., pixels), without undergoing a transform to a different domain.

In some embodiments of the invention, the values of the refinement portion are transmitted uncoded (i.e., not represented by bits or any other code) superimposed on an encoding of the coarse portion. Optionally, the values of the refinement portion are transmitted in a manner such that they degrade gracefully with noise. That is, noise may cause the refinement portion signals to lose some of their accuracy but still convey some of the originally transmitted data. This is in contrast to many transmitted digital signals that are either entirely decoded from the received signals or are not decodable at all from what was received, depending on the noise level. In some embodiments of the invention, the refinement portion is not converted into bits before being transmitted, but rather is directly converted into symbols.

The simple transmission of the refinement portion allows for simpler transmission and reception apparatus. In addition, the uncoded transmission of the refinement portion provides for a more robust transmission, as distorted signals due to noise only affect a small locality of the image, and the noise is not spread over the entire video image. These advantages of uncompressed and/or uncoded transmission of the refinement portion are achieved, in some embodiments of the invention, by transmitting a relatively large refinement portion.

In some embodiments of the invention, the uncoded refinement portion includes a difference between the coarse portion and the refinement portion, for each pixel. Optionally, the coarse portion is generated using a lossy compression method. Alternatively, the coarse portion includes the most significant bits of each pixel and the refinement portion includes the least significant bits of each pixel. Further alternatively, the coarse portion includes the values of some of the pixels of the images, e.g., pixels that form a down-sampling of the image. The refinement portion optionally includes, in this alternative, the values of others of the pixels and/or the difference between an estimation of the interpolation of neighboring pixels included in the coarse portion.

Optionally, each transmitted symbol that carries refinement data carries all the refinement portion data regarding one or more respective color components of one or more image pixels. In some embodiments of the invention, each transmitted symbol carries refinement data that relates only to the one or more image pixels. In some embodiments of the invention, each symbol includes refinement data of two pixels. Linking the refinement data of the symbols to specific image pixels reduces the amount of processing required by the receiver and/or the transmitter.

Alternatively to limiting the refinement portion of each pair of color component and pixel to a single symbol, the refinement portion of a small group of pixels is correlated with a small number of symbols. In an exemplary embodiment of the invention, the refinement portion data of at least one color component is down-sampled in order to conserve bandwidth. For example, the refinement portion values of several (e.g., 5) neighboring pixels are optionally down-sampled to a smaller number (e.g., 4) of points and the down-sampled values are transmitted. In some embodiments of the invention, the correlation of pixels to symbols is different for different color components. In an exemplary embodiment of the invention, the refinement portion data of each pixel is formed of the Y, Cr and Cb color components. The values of the Y component are all transmitted, while the values of the Cr and Cb components are down-sampled.

An aspect of some embodiments of the invention relates to dividing transmitted video signals into a coarse portion and a refinement portion, for superimposed transmission, such that the equivalent bit rate (i.e., the number of bits required for transmitting its content) of the refinement portion is greater than the bit rate of the coarse portion. Optionally, the coarse portion is transmitted encoded, optionally with forward error correction (FEC), while the refinement portion is transmitted un-encoded. In some embodiments of the invention, the refinement portion is transmitted in a manner which does not interfere with the decoding of the coarse portion on which it is superimposed. The decoder optionally first decodes the coarse portion and then decodes the refinement portion based on the difference between the received signal and the decoded coarse portion.

Optionally, the equivalent bit rate of the refinement portion is at least twice the bit rate of the coarse portion. In an exemplary embodiment of the invention, the refinement portion has an equivalent bit rate of about 450 Mbit/sec and the coarse portion has a bit rate of less than 200 Mbit/sec.

An aspect of some embodiments of the invention relates to dividing transmitted video signals into a coarse portion and a refinement portion, for superimposed transmission, such that the coarse portion is compressed using a near-lossless compression method having a compression ratio of less than 1:15, on typical images of the original video images. In some embodiments of the invention, the compression ratio is less than 1:10, for example about 1:8. Although in the prior art it was considered that it would be better to use a stronger compression and hence fit more data content on the available bandwidth, in accordance with some embodiments of the present invention a near lossless compression with a refinement portion is used. Using a near lossless compression allows for a simpler compression procedure and hence simpler compression hardware. In addition, the refinement portion may be transmitted, in some embodiments of the invention, using noisy bandwidth which could not be used efficiently for transmission of the coarse portion.

An aspect of some embodiments of the invention relates to compressing video signals for transmission by repeatedly selecting a pixel distanced from already represented pixels of the image. The selected pixel is encoded and the pixels between the selected pixel and the already represented image portions are recursively encoded as the difference between the actual pixel values and an interpolation prediction of the pixel values. The use of prediction over a vicinity of the pixel rather than directly neighboring pixels achieves better compression results in most transmitted video images.

The use of too small a vicinity in performing the compression, for example, interpolating based only on already coded, directly neighboring pixels, results in a prediction method which misses abrupt changes in the image. Furthermore, using neighboring pixels makes parallel implementation of the compression harder than when using non-neighboring pixels. On the other hand, using too large a vicinity makes the implementation very complex and less efficient, since the correlation between pixels over a long distance is very low. In an exemplary embodiment of the invention, the distance between the selected pixel and the already encoded pixels is between 4-8 pixels.

The encoding of the differences is performed using different codes for different pixel contexts. The codes to be used optionally depend on the location of the pixel for which the difference is encoded, the predicted value of the pixel and/or the value of a neighboring pixel. In some embodiments of the invention, the different codes include different code books, for example different Huffman code books, e.g., adaptive Huffman code books. In some embodiments of the invention, simplified Huffman codes that depend on two or three parameters, such as mean, variance and/or decay rate are used.

In some embodiments of the invention, the compression is lossless, the difference between the actual pixel values and the interpolation pixel values being represented entirely. Alternatively, the difference is represented only partially, so that the compression is lossy. In some embodiments of the invention, the difference between the lossy compression and the actual image is transmitted as a refinement portion along with a coarse portion comprising the results of the compression.

The prediction value of at least some of the pixels are optionally generated based on pixels on opposite sides of the pixel, e.g., above and below, left and right. In some embodiments of the invention, the prediction value of at least some of the pixels are generated based on pixels on three sides (e.g., covering at least 180°) or even four sides of the pixel.

An aspect of some embodiments of the invention relates to transmitting signals that degrade gracefully with noise on a multi-input multi-output (MIMO) link. Gracefully degrading signals are signals that in the presence of some level of noise have a reduced accuracy but are still decipherable. In this respect, the gracefully degrading signals behave as analog signals.

The gracefully degrading signals are optionally included in a refinement portion of the transmitted signals, which is overlaid on a coarse portion. The signals in the coarse portion are optionally digital signals which are either deciphered or not deciphered at all, depending on the level of noise. Therefore, the coarse signals are transmitted with a large safety margin. The refinement portion, on the other hand, degrade gracefully and use a low power level (e.g., 5-7 dB), as loss of the refinement portion is less critical and not all of the data is lost together.

In some embodiments of the invention, the decoder of the MIMO link uses spatial Winner filters, e.g., vector Winner filters, to remove noise, so as to allow decoding of the additional layer of signals.

An aspect of some embodiments of the invention relates to transmitting analog encoded signals on a MIMO link. Optionally, analog television and/or radio signals are divided into a plurality of sub-bands, which are frequency translated onto a single band. In the receiver, a vector Winner filter is optionally used to remove noise due to the MIMO transmission.

An aspect of some embodiments of the invention relates to determining when to change a frequency of transmission in a MIMO link, based on a noise estimation from an additional receiver antenna. Using an additional receiver antenna to determine the noise level, rather than identifying degradation in the transmitted data, allows for faster identification of noise on the channel being used and hence faster switching to a quiet channel. The faster switching to channels that are clear of noise is especially useful when at least part of the signal transmitted is not protected using an error correction code.

Optionally, the receiver also uses the additional antenna for diversity. In some embodiments of the invention, the receiver dynamically selects a predetermined number of antennas whose signals are used for decoding the signals. The noise level is optionally determined from the signal of a receiver antenna that is not used for determining a transmitted data signal. Alternatively, the receiver uses the signals from all its antennas to determine the transmitted signal using over-complete equations. In some embodiments of the invention, the receiver periodically (e.g., once every 0.1-0.5 seconds) does not use the signal from one of the antennas over a short period for the over complete equations and instead uses the signal of the antenna during the short period for determining the noise level.

There is therefore provided in accordance with an exemplary embodiment of the invention, a method of transmitting video images, comprising providing a high definition video stream, compressing the video stream using an image domain compression method, in which each pixel is coded based on a vicinity of the pixel and transmitting the compressed video stream over a fading transmission channel.

Optionally, providing the high definition video stream comprises providing a stream including at least 45 frames per second. Optionally, providing the high definition video stream comprises providing a stream having an uncompressed data rate of above 100 Mbit per second or above 0.6 Gbits per second. Optionally, compressing the video stream comprises compressing without substantial interdependence between frames.

Optionally, compressing the video stream comprises compressing such that the value of each pixel depends directly on no more than 50 neighboring pixels. Optionally, compressing the video stream comprises compressing such that the value of at least some of the pixels depends on non-adjacent pixel values. Optionally, compressing the video stream comprises compressing at least some of the pixels without relation to values of any other pixels. Optionally, transmitting the compressed stream comprises transmitting on a wireless link. Optionally, transmitting the compressed stream comprises transmitting using a joint source and channel encoding method. Optionally, compressing the video stream comprises compressing such that each pixel is coded based on a vicinity of the pixel having a diameter smaller than 20 pixels.

There is further provided in accordance with an exemplary embodiment of the invention, a method of transmitting video images, comprising providing a video image, compressing the video image into a coarse portion, which has, for at least one color component, a bounded difference from the provided image, for a predetermined set of the pixels of the image, representing the difference between the coarse portion and the video image by a refinement portion, mapping the coarse portion and at least part of the refinement portion into symbols of a constellation and transmitting the mapped symbols to a receiver.

Optionally, compressing the video image comprises compressing such that the difference between the coarse portion and the provided image is bounded for substantially all the pixels of the image. Optionally, compressing the video image comprises compressing such that the difference between the coarse portion and the provided image is bounded to have at most ten different possible values or even at most five different possible values. Optionally, the difference between the coarse portion and the provided image is bounded by a maximal value which is less than 5% of the possible values of the provided images. Optionally, compressing the video image comprises compressing such that the difference between the coarse portion and the provided image is bounded for substantially all the color components representing the image. Optionally, mapping the portions comprises mapping the coarse and refinement portions separately into symbols and superimposing the symbols onto each other.

Optionally, mapping the portions comprises mapping the refinement portion into symbols of a constellation having a side to side distance smaller than the distance between the symbols of a constellation of the symbols of the coarse portion. Optionally, the coarse portion is protected by a forward error correction code, while the refinement portion is transmitted without protection by a forward error correction code. Optionally, the refinement portion is mapped uncoded into symbols. Optionally, mapping the portions comprises mapping the refinement portion into a constellation having a discrete number of possible values.

Optionally, transmitting the mapped symbols comprises transmitting over a multi-input multi-output MIMO link. Optionally, representing the difference between the coarse portion and the video image by a refinement portion formed of a plurality of refinement sub-portions, each of which has a smaller side to side constellation size. Optionally, the coarse and refinement portions together represent the video image in a non-compressed standard representation of color video with at most slight filtering.

There is further provided in accordance with an exemplary embodiment of the invention, a method of transmitting video images, comprising providing a video image, compressing the video image into a coarse portion, representing a difference between the coarse portion and the video image by a refinement portion, mapping the coarse portion and at least part of the refinement portion into symbols of a constellation, wherein the refinement portion is mapped uncompressed and transmitting the mapped symbols to a receiver.

Optionally, compressing the video image comprises compressing such that the difference between the coarse portion and the provided image is bounded for substantially all the pixels of the image. Optionally, mapping the portions comprises mapping the coarse and refinement portions separately into symbols and superimposing the symbols onto each other.

Optionally, mapping the portions comprises mapping the refinement portion into symbols of a constellation having a side to side distance smaller than the distance between the symbols of a constellation of the symbols of the coarse portion. Optionally, transmitting the mapped symbols comprises transmitting over a multi-input multi-output MIMO link.

Optionally, representing the difference by a refinement portion comprises determining for each pixel a difference between the coarse portion and the provided image and wherein each value of the refinement portion is related to at most 100 pixels of the image.

Optionally, representing the difference by a refinement portion comprises determining for each pixel a difference between the coarse portion and the provided image and wherein each value of the refinement portion is related to at most 10 pixels of the image.

Optionally, representing the difference by a refinement portion comprises determining for each pixel a difference between the coarse portion and the provided image and wherein each value of the refinement portion represents a difference between the coarse portion and the provided image at a point on the image.

Optionally, each value of the refinement portion represents a difference between the coarse portion and the provided image at a point on the image coinciding with a pixel.

Optionally, at least one value of the refinement portion represents a difference between the coarse portion and the provided image at a point on the image interpolated for two or more neighboring pixels.

Optionally, mapping the portions comprises mapping the refinement portion into symbols of a constellation having a bin for each of the possible values of the difference between the coarse portion and the provided image for a specific point on the image.

Optionally, the refinement portion is mapped uncoded. Optionally, the refinement portion is mapped without undergoing a transform into a non-image domain. Optionally, the coarse portion is protected by a forward error correction code, while the refinement portion is transmitted without protection by a forward error correction code. Optionally, mapping the portions comprises mapping the refinement portion into a constellation having a discrete number of possible values. Optionally, mapping the portions comprises mapping the refinement portion into a constellation such that its value degrades gracefully with noise.

There is further provided in accordance with an exemplary embodiment of the invention, a method of transmitting video images, comprising providing a video image, compressing the video image into a coarse portion, having a first average number of bits per pixel, representing the difference between the coarse portion and the video image by a refinement portion, having an average equivalent bit rate requiring a greater number of bits per pixel, for representation, than the first average number, mapping the coarse and refinement portions into symbols of a constellation and transmitting the mapped symbols to a receiver.

Optionally, the refinement portion is not represented by bits. Optionally, the refinement portion has a predetermined number of values for each symbol. Optionally, compressing the video image comprises compressing such that the difference between the coarse portion and the provided image is bounded to have at most ten different possible values. Optionally, mapping the portions comprises mapping the coarse and refinement portions separately into symbols and superimposing the symbols onto each other.

Optionally, representing the difference by a refinement portion comprises determining for each pixel a difference between the coarse portion and the provided image and wherein each value of the refinement portion is related to at most 10 pixels of the image.

Optionally, the coarse portion is protected by a forward error correction code, while the refinement portion is transmitted without protection by a forward error correction code.

Optionally, the average equivalent bit rate of the refinement portion requires for representation at least twice the number of bits from the first average number.

There is further provided in accordance with an exemplary embodiment of the invention, a method of transmitting video images, comprising providing a video image, compressing the video image into a coarse portion, using a near lossless compression method achieving less than a 15:1 compression ratio, representing the difference between the coarse portion and the video image by a refinement portion, mapping the coarse and refinement portions into symbols of a constellation and transmitting the mapped symbols to a receiver.

Optionally, mapping the portions comprises mapping the coarse and refinement portions separately into symbols and superimposing the symbols onto each other. Optionally, mapping the portions comprises mapping the refinement portion into symbols of a constellation having a side to side distance smaller than the distance between the symbols of a constellation of the symbols of the coarse portion.

Optionally, compressing the video image comprises compressing with a compression ratio of less than 8:1 and/or less than 12:1.

There is further provided in accordance with an exemplary embodiment of the invention, a method of transmitting data, comprising generating a plurality of streams at least partially carrying data which gracefully degrades with noise, transmitting the plurality of streams in parallel through a MIMO transmitter and receiving the plurality of streams by a MIMO receiver. Optionally, the method includes decoding the plurality of symbol streams by the MIMO receiver. Optionally, the MIMO receiver uses a spatial Winner filter to decode the streams. Optionally, the streams include analog streams. Optionally, the streams include symbol streams that at least partially have a representation of data along a continuous analog range. Optionally, the streams include symbol streams that at least partially are selected from a constellation in which closer bins have closer values. Optionally, the streams include symbol streams that represent an overlap of coarse and refinement portions.

There is further provided in accordance with an exemplary embodiment of the invention, a method of receiving data, comprising receiving transmitted MIMO signals using a plurality of antennas including at least one antenna more than used in transmitting the signals, determining from the signal of at least one of the receiver antennas a noise level of a link on which the signals are received and instructing the transmitter to change a transmission parameter responsive to a determination that the noise level is above an allowed level. Optionally, the method includes decoding the signals using the received signals.

There is further provided in accordance with an exemplary embodiment of the invention, a method of compressing an image, comprising encoding values for a plurality of pixels in a vicinity of a block in the image, interpolating predicted values for one or more additional pixels in the block, based on the values of the encoded plurality of pixels and encoding a difference between actual values of the pixels and the predicted values of the pixels, using different codes for different pixel contexts.

Optionally, encoding the difference comprises encoding using a code selected responsive to a location of the pixel in the block. Optionally, encoding the difference comprises encoding using a code selected responsive to the predicted value of the pixel. Optionally, encoding the difference comprises encoding using a code selected responsive to the value of a neighboring pixel. Optionally, plurality of pixels are non-adjacent. Optionally, the block includes 4×8 pixels. Optionally, the block is not square.

### BRIEF DESCRIPTION OF FIGURES

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a wireless transmission system, in accordance with an exemplary embodiment of the invention;

FIGS. 2A and 2B are together a schematic block diagram of a wireless transmitter, in accordance with an exemplary embodiment of the invention;

FIG. 3A is a flowchart of video compression acts, in accordance with an exemplary embodiment of the invention;

FIG. 3B is a flowchart of acts performed in determining the data rate distribution between the coarse and refinement portions, in accordance with an exemplary embodiment of the invention;

FIG. 4 is a schematic block diagram of a joint source-channel coder, in accordance with an exemplary embodiment of the invention;

FIG. 5A is a schematic illustration of a constellation of symbols provided by a mapper of coarse image data on which refinement data is superimposed, in accordance with an exemplary embodiment of the invention;

FIG. 5B is a schematic illustration of a constellation of symbols provided by a mapper of coarse image data on which refinement data is not superimposed, in accordance with an exemplary embodiment of the invention;

FIG. 5C is a schematic illustration of a constellation of symbols provided by a mapper of refinement data, in accordance with an exemplary embodiment of the invention;

FIG. 5D is a schematic illustration of a constellation used for video transmission, in accordance with an exemplary embodiment of the invention;

FIG. 6 is a schematic graph of an exemplary bandwidth capacity of a channel over time, in view of noise on the channel, and the utilization of the channel, in accordance with an exemplary embodiment of the invention;

FIGS. 7A and 7B are together a schematic block diagram of a wireless receiver, in accordance with an exemplary embodiment of the invention;

FIG. 8 is a block diagram of a transmitter, in accordance with another exemplary embodiment of the invention;

FIG. 9 is a schematic illustration of an order of compression of pixels of an image, in accordance with an exemplary embodiment of the invention; and

FIG. 10 is a flowchart of acts performed in compressing an image, in accordance with an exemplary embodiment of the invention.

### DETAILED DESCRIPTION OF EMBODIMENTS

### System Overview

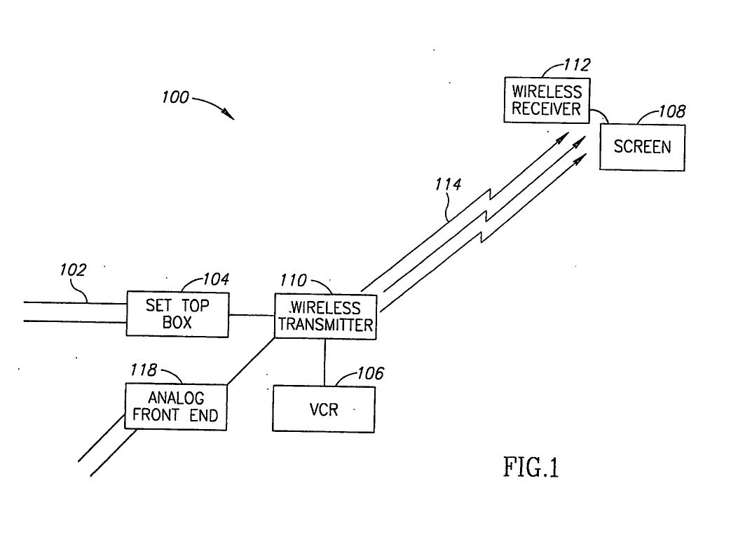

FIG. 1 is a schematic illustration of a wireless transmission system 100, in accordance with an exemplary embodiment of the invention. System 100 comprises a wireless transceiver 110 which receives video signals from a set-top box 104, a VCR 106, a game box, a DVD and/or any other video signal source, for example through an analog front end 118. The video signals are compressed and encoded by wireless transmitter 110 and transmitted on a wireless link 114 to a wireless receiver 112. Wireless receiver 112 decompresses and decodes the signals for display on a screen 108.

Set-top box 104 optionally receives the video signals in a standard format, such as HDTV or SDTV, from a video source, over cables 102. In some embodiments of the invention, the video signals received through cables 102 are encrypted and compressed by the video source and are decompressed and decrypted by set-top box 104. Wireless transmitter 110 generally receives the video signals after decompression and decryption by set-top box 104, such that wireless transmission system 100 does not need decryption keys of set-top box 104, which the operator of video source 104 may desire to keep secret. Alternatively to receiving the video signals over cables 102, set-top box 104 receives the video signals over any other link, such as a satellite link

In some embodiments of the invention, transmitter 110 is included in an audio-video (AV) control box associated with screen 108 or with a general AV receiver.

Screen 108 may include substantially any type of screen, for example an LCD or a plasma screen. Rather than providing video signals to screen 108, wireless receiver 112 may provide the video signals to other display and/or storage apparatus, such as a projector or even a video recorder. Furthermore, transmitter 110 may transmit the signals to a plurality of receivers for concurrent display. Alternatively or additionally, system 100 may include a plurality of transmitters which transmit same or different content to different end-units. For example, system 100 may include a plurality of different screens and each transmitter provides a respective screen with the video signals it is to display.

Link 114 optionally uses an unregulated frequency sub-band of a maximal size (e.g., 20-40 MHZ) allowed for use by a single unit. In an exemplary embodiment of the invention, link 114 may change between a plurality of frequency sub-bands, according to the noise levels on the sub-bands. Optionally, transmitter 110 transmits signals at power levels allowed for unregulated transmissions. The range of link 114 is optionally up to about 5-10 meters, depending on the transmission power level. It is noted, however, that some aspects of the present invention may be used in other environments and/or under other conditions, such as links with larger or smaller bandwidth and/or lower or higher power levels, depending on the prevailing needs and regulations.

In some embodiments of the invention, wireless transmitter 110 and receiver 112 operate according to a multiple input multiple output (MIMO) method. In an exemplary embodiment of the invention, four parallel transmitters are used, each using 20 MHz. Generally, under such conditions, an effective transmission bandwidth of 60-70 Mega symbols per second is achieved. In the prior art, each symbol generally represents between 3-5 bits, such that the available raw data rate of link 114 is 180-300 Mbit/sec. Using available compression methods, this bandwidth is not sufficient to carry video signals at a rate of 1.5 Gbits/sec.

As described in detail below, in some embodiments of the invention, link 114 carries about 180-250 (e.g., 200) Mbits/sec of coarse data and the equivalent of another 400-600 Mbits/sec of refinement data. Using methods of the present invention, a compression ratio of between 2:1 and 3:1 is sufficient to allow transmission of video data of 1.5 Gbits/sec over link 114. As explained below, the refinement data is transmitted with a low safety margin and therefore has a high data content. Using the bandwidth of the refinement data to simply increase the channel capacity would add very little, as the coarse portion requires a large safety margin.

In an exemplary embodiment of the invention, a video stream includes 62.2 million pixels per second. The video stream is optionally compressed into a coarse portion of about 1 bit per pixel per color component, i.e., 3 bits per pixel. In some embodiments of the invention, overhead signals are added, such that with the overhead and audio (e.g., 1-2 Mbps), a rate of about 4 bits per pixel (e.g., 250 Mbps) is optionally used to represent the compressed video stream. The remaining data of the compressed video stream is optionally transmitted as refinement data.

Transmitter 110 is optionally implemented by three chips one of which includes base band logic, another includes RF components, such as up converter logic, and a third chip includes transmission amplifiers. Receiver 112 is optionally implemented on two chips, a first base band chip and a second RF component, e.g., down-converter, chip. It is noted, however, that any other implementation of the embodiments of the invention may be used, including using fewer or a greater number of chips and/or using non-chip implementations. In an exemplary embodiment of the invention, a same chip is used for both the transmitter and the receiver. Optionally, such a chip includes base band logic circuits for both the receiver and the transmitter and in each of transmitter 110 and receiver 112 only one of the circuits is activated. Such a duplication may allow faster development of the chip.

### Transmitter

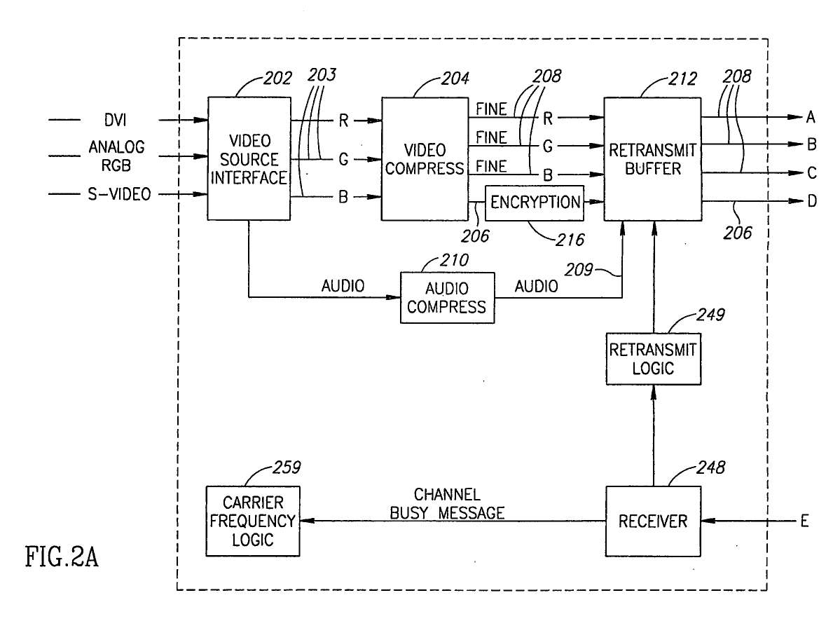

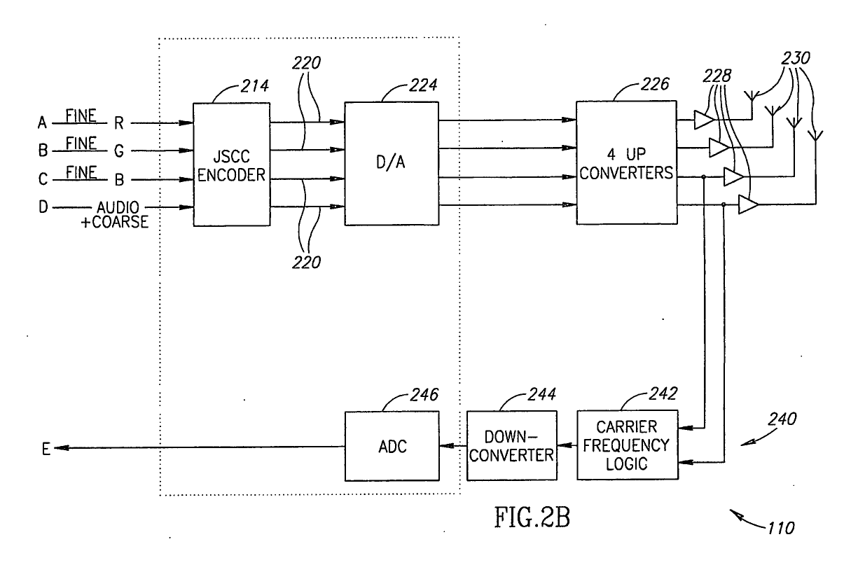

FIGS. 2A and 2B show a schematic block diagram of wireless transmitter 110, in accordance with an exemplary embodiment of the invention. Transmitter 110 comprises a video interface 202 through which signals to be transmitted are received from set-top box 104. The signals may be received in a digital format, e.g., digital video interface (DVI) or HDMI, or in an analog format (e.g., component format (RGB) or Y, Cr, Cb). A video compression unit 204 optionally compresses the video signals 203 into a lossless or substantially lossless format. In some embodiments of the invention, the compressed format includes a coarse portion 206 which includes a moderately lossy compression of the video signals and one or more refinement (fine) portions 208, which represent the difference between video signals 203 and a decompression of coarse portion 206.

In some embodiments of the invention, a separate audio compression unit 210 compresses audio signals accompanying the video signals, into compressed audio signals 209. A joint source-channel coding (JSCC) encoder 214 (FIG. 2B) receives coarse portion 206, refinement portions 208 and compressed audio 209 and encodes them for transmission by one or more antennas 230. Optionally, JSCC encoder 214 encodes the compressed signals 206, 208 and 209 into a number of streams 220 corresponding to the number of antennas 230, such that each antenna has a corresponding stream 220. Streams 220 are optionally passed through a D/A converter 224 and the resulting analog signals are passed through an up-converter 226 and power amplifiers 228 to antennas 230. The operation of one implementation of these elements is described hereinbelow in detail. It is noted that other implementations and/or transmission apparatus may be used in accordance with the invention.

In some embodiments of the invention, a retransmit buffer 212, between video compression unit 204 and JSCC encoder 214, stores the compressed signals in case they are required for retransmission. Optionally, the compressed signals are stored until they are transmitted and/or for a predetermined time after transmission. Alternatively, retransmit buffer 212 is located between JSCC encoder 214 and D/A converter 224. Further alternatively, a retransmission buffer is not used, for example when a strong forward error correction (FEC) code is used. In some embodiments of the invention, all the signals of the coarse portion are protected with a same strength FEC. Alternatively, a stronger FEC may be used for more important data, while less important data is protected by a weaker FEC. For example, more protection may be applied to a base grid of the transmitted images (e.g., including every second pixel), while the remaining pixels not belonging to the base grid are less protected.

An encryption unit 216 optionally encrypts coarse portion 206 so that it cannot be used by eavesdropping apparatus. Optionally, refinement portions 208 are not encrypted as they usually cannot be used without coarse portion 206, which is encrypted. Alternatively, refinement portions 208 are encrypted for additional security. In some embodiments of the invention, however, no encryption is used, for simplicity. In some embodiments of the invention, encryption unit 216 does not change the data rate of coarse portion 206. Alternatively, encryption unit 216 may change the data rate to a small extent as required by the encryption method used.

A return path 240 optionally includes carrier frequency logic 242, a down-converter 244, an analog to digital converter 246 and a receiver 248 (FIG. 2A). Return path 240 optionally receives feedback from receiver 112 (FIG. 1), for example acknowledgements and/or requests for retransmission. According to the feedback received by receiver 248, a retransmit logic circuit 249 optionally instructs retransmit buffer 212 to provide for retransmission signals that are required by receiver 248. Alternatively or additionally, return path 240 is used to receive feedback on the quality of the frequency channels used. Optionally, receiver 112 monitors the available frequency bands for their noise and/or attenuation levels and periodically instructs transmitter 110 as to the frequency band to be used for transmission. A carrier frequency logic unit 259 optionally receives the instructions from receiver 112 and changes the transmission band accordingly. It is noted that, in some embodiments of the invention, no feedback is used and return path 240 is not included in transmitter 110. Further alternatively or additionally, return path 240 is used to transmit remote control instructions received from a viewer, to set-top box 104.

In some embodiments of the invention, video interface 202 is adapted to receive signals in only a single format. Alternatively, video interface 202 is adapted to receive signals in any one of a plurality of different formats. In some embodiments of the invention, video interface 202 is adapted to decrypt signals it receives, when necessary.

### Compression

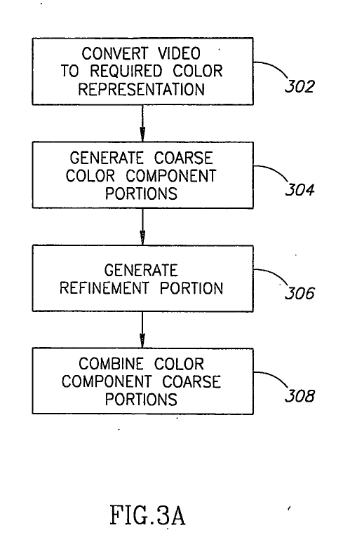

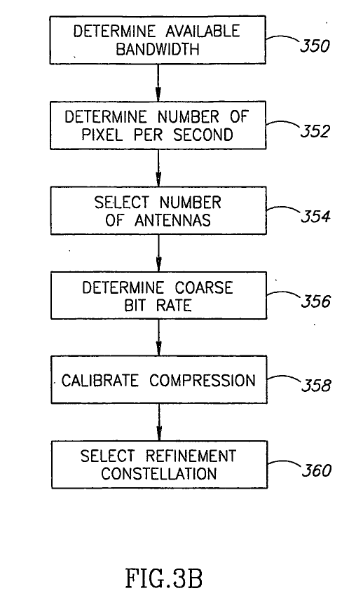

FIG. 3A is a flowchart of the acts performed by video compression unit 204, in accordance with an exemplary embodiment of the invention. The received video signals are converted (302) into a suitable color format. For example, the signals may be converted into the Y, Cr, Cb color representation or into the Y, U, V representations. These representations are optionally used as they allow standard removal of least significant bits of one or more of the color components without substantially affecting the image quality. The removal of the least significant bits may be performed by sub-sampling one or more of the components for example using one of the 4:2:2, 4:2:0 or 4:1:1 schemes. Alternatively, the RGB representation is used, for example if the signals are received in this format in order to reduce the processing power required for format conversion.

For each color component, a coarse portion color component, which is generally a lossy compression of the color component of the image, is generated (304). Concurrently and/or thereafter, a refinement portion 208 is generated (306) for the color component. The coarse portion color components are optionally combined (308) into a single coarse portion.

In some embodiments of the invention, the generation (304) of the coarse portion color components and the generation (306) of the refinement color components are performed in parallel using a single compression method. Optionally, the coarse and refinement portions are generated using a compression method in which the difference between the original video signal and the decompressed signal of each image pixel is smaller than a predetermined maximal threshold. Optionally, the maximal threshold is of a level of less than 5% or even 2% of the possible values, such that the bandwidth required for transmitting the difference is limited.

In an exemplary embodiment of the invention, the maximal threshold per image pixel is 2 for each color component, i.e., the difference may be −2, −1, 0, 1, 2. When each color component of a pixel is represented by 8 bits, the maximal difference per color component of a pixel is less than 1% or more accurately 2/256. In other embodiments of the invention, higher error values are allowed, for example between −3 to 3 or even between −5 to 5. Optionally, the allowed error range is symmetrical around the zero value. Alternatively, the allowed error value is non-symmetrical, for example in order to allow representation of the error value by a predetermined number of bits and/or by an even constellation (e.g., 6×6 QAM).

In some embodiments of the invention, the compression (302) is such that less than 1-5% of the pixels have the maximal difference allowed, e.g., 2 or -2, so that the error in case the refinement data is lost is not too great. Alternatively, the compression is performed in a manner which does not prefer small differences over large differences, as long as the difference is in the range which may be encoded by the refinement portions 208.

Alternatively to the compression being limited to a maximal threshold of the difference, the compression is such that the maximal threshold is exceeded relatively rarely, for example in less than 0.1-1% of the pixels.

Alternatively to the predetermined maximal threshold relating to all the pixels of the transmitted images, the error values of some pixels are not bounded. The error values of these pixels are optionally transmitted separately from those of the pixels having bounded errors, for example with the coarse portion. In an exemplary embodiment of the invention, the error values for at least some of the frame pixels of the image are not bounded.

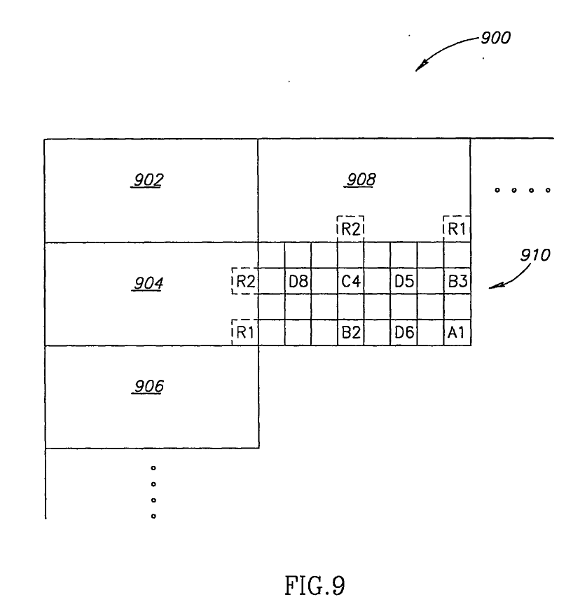

In an exemplary embodiment of the invention, lossy compression resulting in the generation (304) of the coarse portion is performed using a near lossless compression method (e.g., with a loss rate of 1-5%), such as a near lossless compression based on the low complexity lossless compression for images (LOCO-I). For example, the correction value relative to the prediction may be encoded with an accuracy not including the least significant bit. Alternatively, the method described below, with reference to FIG. 9, is used.

Further alternatively, other compression methods are used, such as the ARIDPCM compression method, the FELICS compression, a context based lossless interband compression (CALIC) color-based compression scheme, a waveform compression, a Sunset CB9 compression, fractal compression, Lempel-Ziv (LZ) compression and/or variations thereof. In some embodiments of the invention, when the difference between the original video signals and the result of the lossy compression are larger than desired to be represented by refinement portions 208, some of the difference data is included in coarse portion 206 while the rest of the difference representation is included in refinement portions 208. For example, the coarse portion may include a list of pixels that have a difference greater than can be encoded by the refinement portion 208 and the extent of the difference. The receiver uses this list to correct the decompressed images, in addition to the use of refinement portions 208.

Alternatively to using a compression method which provides the refinement portions together with the coarse portion, the refinement portions are generated after the coarse portion. Thereafter, compression unit 204 decompresses the coarse portion and determines the difference between the original video signals and the decompressed coarse portion. Refinement portions 208, which represent the determined difference, are then generated (306).

It is noted that in accordance with the present invention the compression method may be simple (e.g., of low processing complexity), as refinement portion 208 provides correction data for the difference between the compression and the original image. The simplicity of the compression may allow using a relatively cheap processor in receiver 112 and/or in using off the shelf compression schemes not specifically devised for the present invention. Alternatively, a complex compression method, which accurately controls the difference between the compressed image and the original image, is used, so as to limit the amount of bandwidth required by the refinement portion and/or the amount of loss of refinement data.

In some embodiments of the invention, the refinement portions 208 represent the entire difference between the compressed video signals and the original video signals. Alternatively, the refinement portion 208 represents only part of the difference between the compressed video signals and the original video signals, such that the transmitted data (both coarse and refinement portions) represent a lossy compression of the image. Further alternatively or additionally, some of the difference between the compressed and original video signals is represented by data structures included in the coarse portion 206.

Referring in more detail to combining (308) the coarse portion color components, in some embodiments of the invention, the color components of the coarse portion are concatenated without performing additional compression based on the correlation between the different color components. Alternatively, in the combining, additional compression based on similar values of different color components is performed.

In some embodiments of the invention, the refinement portions 208 of the different color components have the same error range. Alternatively, different color components have different error ranges. Optionally, the refinement portions 208 of the different color components are not combined, so as to allow simple decoding of the refinement portions.

### Data Rate Distribution Between Coarse and Refinement Portions

Optionally, the compression ratio used in generating coarse portion 206 is chosen based on the available bandwidth for the refinement portion, such that the compression loss fits into the refinement portion. The compression ratio and resultant compressed bit rate are optionally adjusted such that coarse portion 206 and refinement portion 208 advance at substantially the same pixel rate, such that the refinement data received matches the received coarse portion 206, and there is no need for large buffering resources.

FIG. 3B is a flowchart of acts performed in determining the data rate distribution between the coarse and refinement portions, in accordance with an exemplary embodiment of the invention. The available bandwidth is determined (350), for example, according to the regulations in the country in which system 100 is to be employed. Generally, bandwidths of between about 20-40 MHz are allowed for use. The number of pixels per second in the transmitted images are determined (352). Conventionally, 62 million pixels per second are transmitted, with three color components for each pixel.

A number of transmission antennas 230 to be used for the MIMO transmission is selected (354). In some embodiments of the invention, the number of antennas is selected as the lowest number that allows each pixel color component to have a corresponding value in a transmitted sample. For example, if each Hz corresponds to a single transmitted sample and each sample carries two values (e.g., using complex samples), five antennas are used to achieve about 20×5 complex samples. It is noted that fewer samples may be achieved due to cross talk and other transmission control issues.

Alternatively to using the lowest number of antennas that achieves a transmitted sample value for each pixel, a larger number of antennas (e.g., 6-8 antennas) may be used for robustness. Further alternatively or additionally, a smaller number of antennas is used to reduce hardware costs and processing complexity of the MIMO reception. Optionally, the number of color components transmitted is down-sampled by using a sub-sampled format as described above. In an exemplary embodiment of the invention, 4 antennas which achieve an effective rate of 75 Mega-samples per second are used.

The bit rate that can be achieved for the coarse portion using the number of samples carried by the selected number of antennas, is determined (356). In an exemplary embodiment of the invention, a capacity bit rate of about 200 Mbits per second is achieved using the four antennas.

The compression method is calibrated (358) so that the images fit into the determined coarse bit rate. The calibration optionally includes setting the error threshold allowed for each pixel. According to the error threshold, a constellation is optionally selected (360) for the error values. For example, if the error threshold is 3, a constellation of 7×7 is optionally used to represent for each of two error values, any one of the values −3, −2, −1, 0, 1, 2, 3.

In some embodiments of the invention, the coarse portion includes about 200 Mbits/second and the number of samples that carry refinement data is about 75 Mega-samples. Assuming that each pixel color component may have 5 possible values and each sample carries two error values, the equivalent bit rate of the refinement data is 75M×log₂5×2, which is about 350 Mbits per second. Such an amount of data could not be transmitted as bits by increasing the capacity of the coarse portion at the expense of not including the refinement portion.

In some embodiments of the invention, the coarse portion has a compressed data rate of between about 2.4-4 bits per pixel, equivalent to a compression rate of between about 6:1 to 12:1, as the video signals generally include between 8-10 bits of three color components for each pixel. It is noted that such compression ratios are more easily achieved due to the use of refinement portions 208 that correct for differences between the compressed data and the original video signals. In an exemplary embodiment of the invention, the coarse portion 206 has an average compressed data rate of between about 0.8-1.3 bits/pixel/color component.

Alternatively, a stronger compression is used in generating the coarse portion 206, leaving a larger amount of data for refinement portions 208. Further alternatively, a weaker compression, requiring less data for refinement portions 208, is used in generating coarse portion 206. For example, a compression ratio of 4:1 or 5:1 may be used, with a correction value for each two pixels rather than for every pixel.

### JSCC Encoding

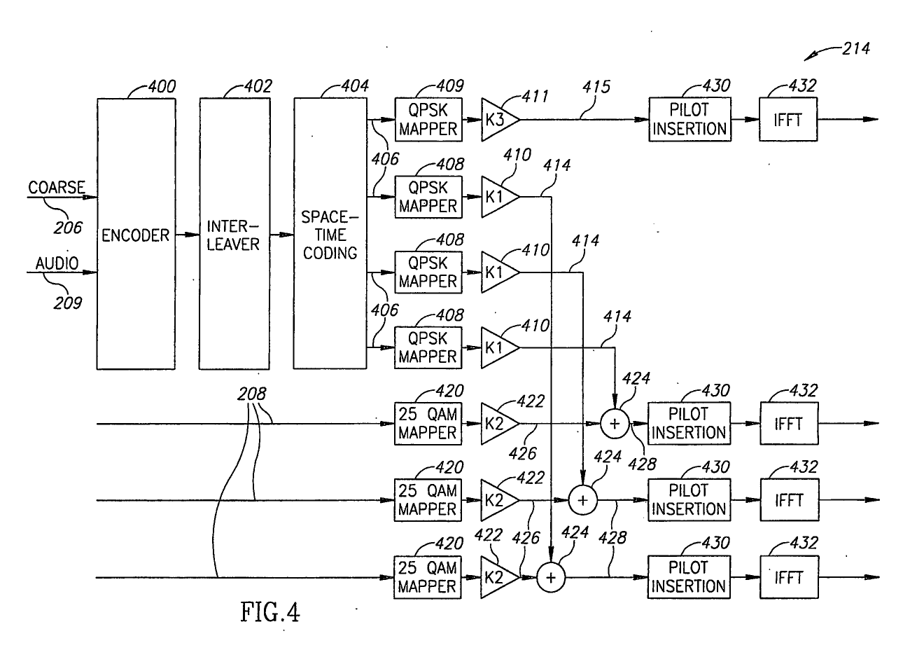

FIG. 4 is a schematic block diagram of JSCC encoder 214 (FIG. 2), in accordance with an exemplary embodiment of the invention. JSCC encoder 214 optionally includes an encoder 400, which encodes coarse portion 206 and compressed audio 209. The encoded data is optionally interleaved by an interleaver 402, as is known in the art. A space-time coder 404 optionally divides the encoded signals from interleaver 402 into a number of streams 406 corresponding to the number of antennas 230 used for transmission. Optionally, space-time coder 404 distributes the encoded data over a plurality of frequency bins as well as over a plurality of time and/or space bins (i.e., different antennas). Alternatively, for simplicity, a different code is used by coder 404 for each frequency bin, and the values in each frequency bin are not affected by the values of the other frequency bins.

Each of streams 406 is optionally passed to a separate mapper 408 and 409. The mapped symbols from mappers 408, which are to be combined with refinement portions, are optionally amplified by amplifiers 410, having an amplification factor K1, into coarse symbol streams 414. The mapped symbols from mapper 409, which are transmitted without a combined refined portion, are optionally amplified by amplifier 411, having an amplification factor K3, into a coarse symbol stream 415. In some embodiments of the invention, K1 is greater than K3 in order to overcome the noise effect of the added refinement portion. Alternatively or additionally, mapper 409 uses a more dense symbol map, which takes into account the fact that a refinement signal is not combined with symbol stream 415. In some embodiments of the invention, however, K3 is equal to K1 and/or mappers 408 and 409 are substantially the same, and the refinement signals are at low signal levels that substantially do not interfere with the transmission of the coarse signals.

Each of refinement streams 208 is optionally passed to a respective mapper 420 and a respective amplifier 422, having an amplification level K2, resulting in refinement symbol streams 426. Adders 424 are used to superimpose the refinement symbol streams 426 onto coarse symbol streams 414, forming combined streams 428, for transmission.

Optionally, wireless transmitter 110 includes at least the same number of antennas 230 as the number of refinement portions 208, such that each refinement symbol stream 426 is superimposed on a separately transmitted coarse symbol stream 414. In some embodiments of the invention, wireless transmitter 110 includes more antennas 230 than refinement portions 208, such that at least one coarse symbol stream 415 is transmitted without a superimposed refinement symbol stream 426. Alternatively, the number of antennas used is the minimal number which is sufficient to transmit the video data at the desired quality level. In accordance with this alternative, each antenna carries refinement data mounted on coarse portion data.

Alternatively to each refinement portion 208 being carried by a single refinement symbol stream 426, the refinement portions 208 are not correlated with specific antennas, such that the refinement portion 208 of a specific color component is carried by two or even three antennas.

In some embodiments of the invention, the error value of one or more of the color components (e.g., Cr and/or Cb) has fewer possible values than other color components (e.g., Y). In an exemplary embodiment of the invention, the possible values of the Cr and Cb components of a single pixel are encoded into a single symbol. Alternatively or additionally, the values of one or more of the color components are sub-sampled and samples are associated with sub-samples rather than with pixels.

Combined streams 428, as well as coarse symbol stream 415, which does not carry a superimposed refinement symbol stream, are optionally passed through pilot insertion units 430 and inverse Fourier transform units (IFFT) 432 to D/A converter 224 (FIG. 2B), as is known in the art for OFDM transmission systems. Alternatively, other modulation methods may be used, such as time domain modulation.

Referring in more detail to encoder 400 and interleaver 402, encoder 400 and/or interleaver 402 optionally use methods known in the art for encoding compressed audio and images. In an exemplary embodiment of the invention, encoder 400 comprises a Reed Solomon (RS) encoder combined with a trellis encoder. Alternatively, any other forward error correction (FEC) encoder is used. Optionally, encoder 400 increases the number of bits in the data it handles by between about 25-60% (e.g., 33%), for example increasing the compressed data rate from about 3-3.3 bits per pixel to about 4-4.5 bits per pixel. In another exemplary embodiment of the invention, the data rate is increased from about 2.4 bits per pixel to about 4 bits per pixel. Alternatively, when retransmission is not used and/or when more bandwidth is available, encoder 400 increases the data rate by a greater amount. Further alternatively, weaker encoding is used, adding fewer data bits. Further alternatively, an encoder is not used, dependent on a high signal to noise ratio and/or the availability of retransmission.

Amplification level K1 of amplifiers 410 is optionally sufficiently high, such that for the FEC protection used, the expected noise levels and the types of mappers 408 and 409 used, the chances of data loss is very low, e.g., less than 10⁻⁹ or even 10⁻¹¹. Amplification level K2 is optionally set to a level sufficiently low so that it does not interfere with the detection of coarse portion 206 when the refinement symbol streams 426 are superimposed on the coarse symbol streams 414.

In some embodiments of the invention, amplification levels K1 and K2 have predetermined values selected according to average noise levels and desired loss rates of the coarse portion 206 and refinement portions 208. Alternatively, K1 and K2 are set adaptively based on feedback from receiver 112. For example, K1 may be adjusted according to how much the FEC of the coarse portion 206 was required for the decoding. If the FEC was not required or nearly not required, K1 may be reduced, while if the FEC was nearly entirely required or the decoding was not successful, K1 is increased. Optionally, K2 is adjusted according to the changes in K1, so as to maximize the utilization of the allowed power levels.

### In Constellation

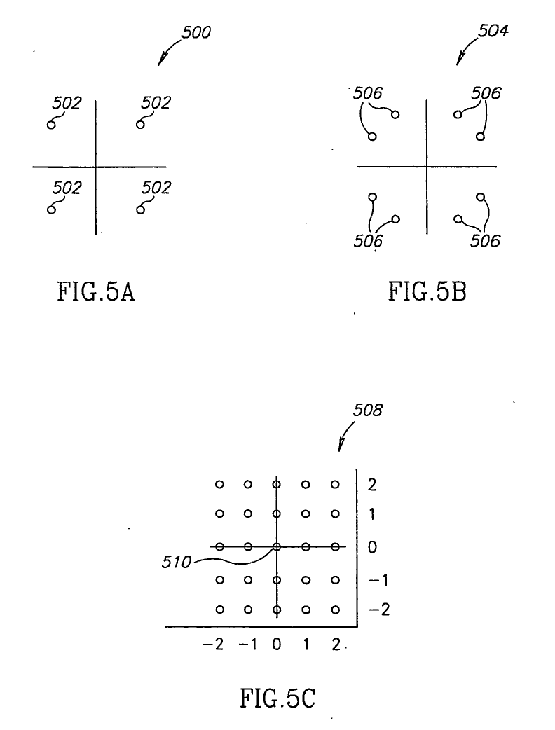

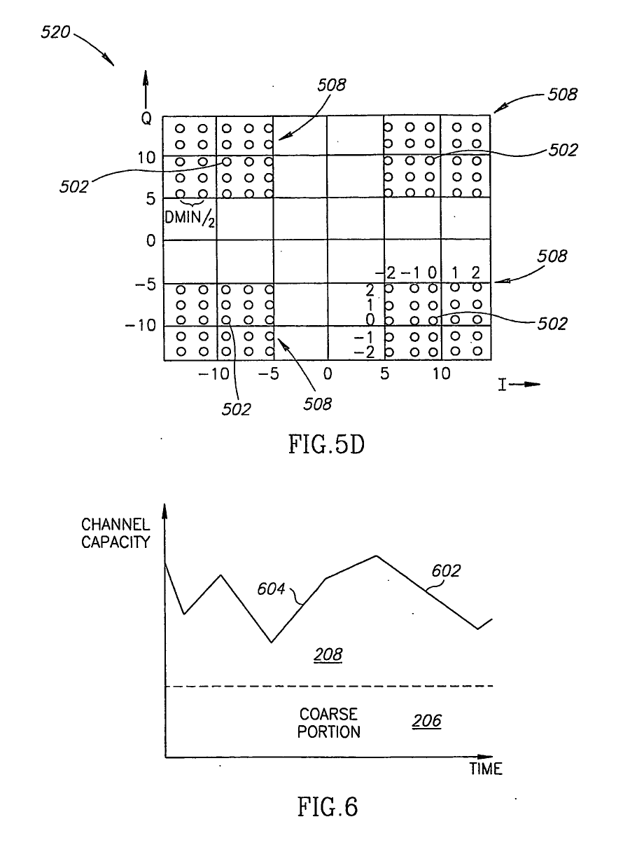

FIG. 5A is a schematic illustration of a constellation 500 of symbols provided by mapper 408, in accordance with an exemplary embodiment of the invention. Optionally, each of mappers 408 comprises a quadrature phase shift keying (QPSK) mapper. Optionally, constellation 500 includes four possible points 502, such that each symbol in mappers 408 represents two bits. The relatively small constellation is optionally used in order to have a high robustness for coarse portion 206 and to allow for sufficient distinctness of the bins of the symbols of mappers 420 superimposed on the symbols of mappers 408.

Other coarse portion constellations may be used, for example circular constellations, which allow efficient encoding of 3 or 5 bits per symbol, or non-symmetrical constellations, which allow unequal protection of different sections of the coarse portion.

FIG. 5B is a schematic illustration of a constellation 504 of symbols provided by mapper 409, in accordance with an exemplary embodiment of the invention. Optionally, mapper 409 comprises a same type of mapper as mapper 408, e.g., a quadrature phase shift keying (QPSK) mapper, although with a larger constellation, since symbols from mapper 420 are not superimposed on the symbols from mapper 409. In some embodiments of the invention, constellation 504 includes eight possible points 506, such that each symbol from mapper 409 represents three bits. Alternatively, a QAM constellation may be used by mapper 409, for example a 16-QAM constellation, representing four bits. The relatively small number of points 502, 506 in constellations 500 and 504 is optionally used in order to ensure a very low chance of data loss. It is therefore noted that if the wireless link has a higher signal to noise ratio, if a stronger FEC is used and/or if otherwise the conditions are different, a larger constellation may be used in accordance with embodiments of the invention. Alternatively or additionally, when any of the above more favorable conditions are available, a smaller distance between constellation points is used for constellation 500, without increasing the number of constellation points, allowing more room for refinement portions 208.

Alternatively or additionally, a non-symmetrical constellation may be used for the refinement portion. For example, when a single symbol is used for different color components, such as Y and Cr, a rectangular constellation which gives a higher safety margin to the Y component is optionally used. Alternatively or additionally, the rectangular constellation may give more possible values to the Y component than to the Cr component. For example, the Y component may be allowed a range of values between −3 to 3, while the Cr component allows values between −1 to 1.

Further alternatively or additionally, a non-square (e.g., circular) constellation may be used, to achieve better power efficiency at the expense of increased complexity. In an exemplary embodiment of the invention, an elliptical constellation, which gives more weight to Y color components than to Cr color components, is used. FIG. 5C is a schematic illustration of a constellation 508 of symbols provided by mapper 420, in accordance with an exemplary embodiment of the invention. Mappers 420 of refinement portions 208 optionally include quadrature amplitude modulation (QAM) mappers in which each symbol represents the quantization error of two pixels, the error of one pixel represented by the I direction and the error of the second pixel by the Q direction. In constellation 508, central point 510 optionally represents no difference between coarse portion 206 and the actual image for the specific two pixels in the specific color component corresponding to the mapper 420. Without loss of generality, points to the left of central point 510 optionally represent discrepancies in the first of the two pixels in a first direction and points to the right of central point 510 represent discrepancies in the first of the two pixels in the other direction. In a similar manner, points above and below central point 510 represent discrepancies in the value of the second pixel between coarse portion 206 and the actual image. In an exemplary embodiment of the invention, constellation 508 includes 5×5 points, in order to represent any of the five values −2, −1, 0, 1 and 2 for both the pixels represented by each symbol.

FIG. 5D is a schematic illustration of a constellation 520 resulting from super-imposing constellation 508 on constellation 500, in accordance with an exemplary embodiment of the invention.

QPSK points 502 in constellation 500 are optionally separated by a maximal distance possible according to the allowed transmission power. The distance between each two adjacent constellation points within constellation 508 (represented by Dmin/2) is optionally selected according to the expected noise rate, such that an error between two adjacent constellation points has a probability of less than a first predetermined threshold, e.g., 1%. Optionally, the chances of an error of Dmin, between non-adjacent constellation points is less than a second predetermined threshold, e.g., 0.0001%.

In an exemplary embodiment of the invention, the link has an average effective signal to noise ratio (SNR) of about 40 dB. The transmission with a 16 QAM constellation requires an average SNR of 13.6 dB, such that the safety margin is about 26 dB. The refinement portion in this example optionally uses between 5-8 dB, leaving the coarse portion a substantial safety margin of 18-21 dB. Alternatively, a smaller or larger portion of the safety margin is used for the refinement portion.

In some embodiments of the invention, the distances between the points of constellation 500 are substantially the same as would be used if constellation 508 were not superimposed on constellation 500.

It is noted that constellation 520 is presented by way of example and many other constellation combinations may be used. For example, a single mapper may be used instead of mappers 408 and 420, using for example a 128 QAM or OFDM constellation, in which some bins are left empty to provide higher protection for the data of coarse portion 206.

Alternatively to using the same constellation for each of mappers 420, in some embodiments of the invention, different constellations are used for different color components according to the importance of the color components. For example, when the YUV or Y, Cr, Cb representation is used, the importance of the U and V components is less important than that of Y and therefore, their mappers may include bins for less possible correction values. This alternative may be used for example for relatively noisy environments, as it may require additional processing power for the conversion into the YUV representation.

In an exemplary embodiment of the invention, in the compression, one of the color components is allowed to have a higher maximal error than other color components. Optionally, on one of antennas 230, the coarse data has a slower data rate, e.g., a single bit per symbol, and mapper 420 of that color component has a constellation that suffices for the higher maximal error. Alternatively or additionally, the constellation used changes over time according to the available conditions of the link. For example, when the transmission conditions are more harsh, a nine point QAM constellation may be used for refinement portion 208, in some or all of antennas 230. Optionally, the harsh conditions are reported by receiver 112 to transmitter 110 on the back channel.

As described above, in some embodiments of the invention, the refinement data has no FEC protection. The refinement data is optionally mapped into its constellation uncoded, with a 1:1 scaling function leading from the error values to the bins of the map constellation. Thus, detrimental noise does not necessarily cause loss of all the refinement data. The data is optionally encoded such that low levels of noise cause a small error (e.g., +−1), while high noise levels cause a higher loss.

In other embodiments of the invention, the refinement data has local FEC protection, for a relatively limited number of pixels. Such protection increases the chances the refinement data is received, at the risk that the refinement data for all the inter-protected pixels will be lost together.

In an exemplary embodiment of the invention, each symbol transmission of all four antennas 230 carries 10 coarse data bits (e.g., 2 bits by each mapper 408 and 4 bits by mapper 409) and refinement data for 2 pixels. As the refinement data is representable by about 7 bits per pixel (5×5×5 possibilities per pixel, as there are 3 color components and 5 possible values), the data transmitted in each pixel round includes 10 bits of coarse data representing about 2 pixels, and the equivalent of 14 bits of refinement data, representing about 2 pixels. It is noted, however, that the bits of the coarse data are transmitted with higher reliability than the symbols of the refinement data.

The refinement data, in some embodiments of the invention, has an equivalent bit rate which is greater than the compressed bit rate of the transmitted coarse data, optionally being greater by at least 40-60%.

FIG. 6 is a schematic graph of the available bandwidth over time, and the utilization of the bandwidth, in accordance with an exemplary embodiment of the invention. Line 602 represents the capacity of the channel according to the instantaneous noise conditions. Coarse portion 206 is transmitted in a portion of the channel which is substantially always available, or is available at a very high percent of the time, e.g., at least 95% or 98% of the time. The FEC protection used is optionally selected according to the number of expected errors in coarse portion 206. The remaining bandwidth not used by coarse portion 206 is optionally used by refinement portion 208. At points at which the capacity is low, such as point 604, some of the refinement data is lost. Alternatively to using for refinement portion 208 all the bandwidth available even if it may involve a high loss rate, in some embodiments of the invention, only bandwidth which has a loss rate beneath a given percent, e.g., 10-20%, is used for the refinement portion.

Rather than using the noisy bandwidth for the unprotected refinement portion 208 and the safe bandwidth for coarse portion 206, in some embodiments of the invention the unprotected refinement portion is transmitted on safe bandwidth, while FEC protected coarse portion 206 is transmitted on the noisy bandwidth. This may be done, for example by using opposite values of K1 and K2 than suggested above. Optionally, in these embodiments, a strong FEC is used on coarse portion 206 which provides a very low data loss rate. In some of these embodiments, a strong processor is used in receiver 112, which can handle the decoding of the strong FEC.

Further alternatively, coarse portion 206 may be transmitted in a plurality of different bandwidth sections. For example, some of the data representing coarse portion 206 (e.g., video data) may be transmitted on relatively safe bandwidth with a low bandwidth consumption FEC, while the remaining data representing coarse portion 206 (e.g., audio data) is transmitted on highly noisy bandwidth with a very strong FEC. The refinement portion 208 is optionally transmitted on intermediate bandwidth. In this alternative, bandwidth which is useless for any specific piece of data due to a high loss rate, is used with a high protection FEC.

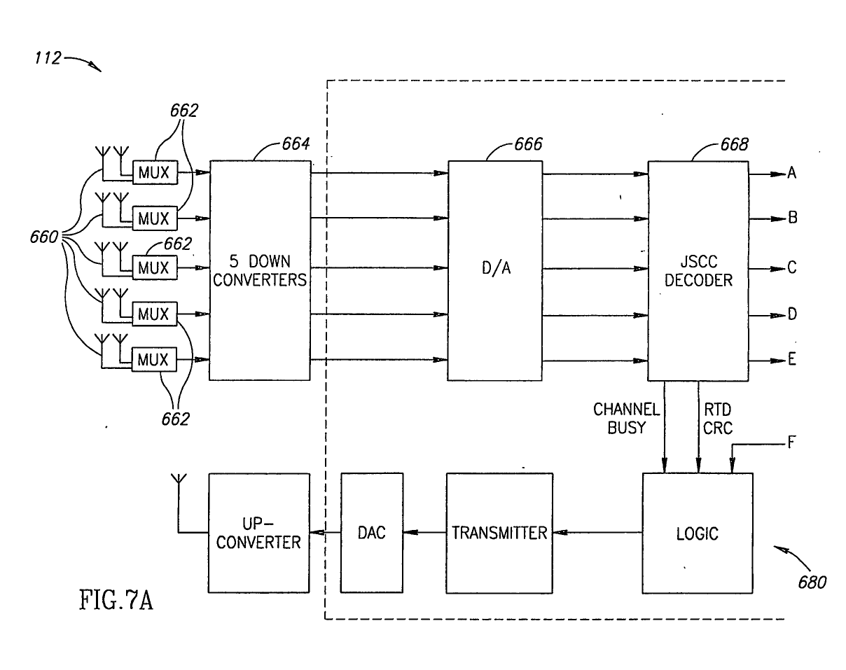

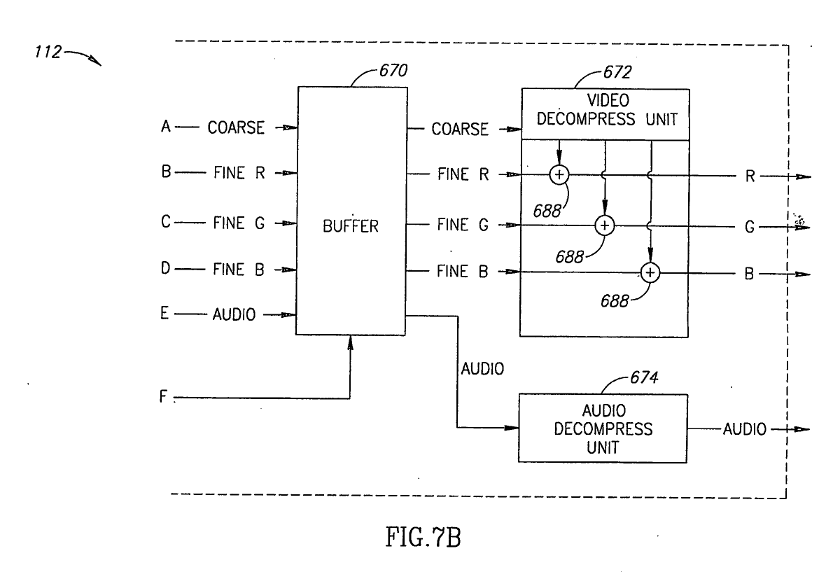

FIG. 7 is a block diagram of receiver 112, in accordance with an exemplary embodiment of the invention. Signals transmitted from transmitter 110 are received through one or more antennas 660, of receiver 112. Optionally, receiver 112 includes at least one antenna 660 more than the number of antennas 230 of transmitter 110, so as to allow selection of higher quality signals from the antennas providing higher quality signals and/or in order to allow determination of the noise level based on the signal of one of antennas 660.

In an exemplary embodiment of the invention, receiver 112 includes five pairs of antennas 660. Multiplexers 662 select a better quality signal of a single antenna 660 from each pair of antennas. The selected signals are passed through down-converters 664 and D/A converters 666, as is known in the art.

The digitized received streams from D/A converters 666 are passed to a JSCC decoder 668 which selects from the signals of antennas 660 a number of received streams equal to the number of transmitted streams from antennas 230 of transmitter 110 (FIG. 2B). In some embodiments of the invention, the selection of the received streams includes discarding the signal of one or more streams that currently have a highest noise level. Thereafter, JSCC decoder 668 optionally extracts the original transmitted signal streams from the selected streams using known MIMO methods of the art. Alternatively to selecting the received streams with the best signal quality, JSCC decoder 668 extracts the original transmitted signal streams using all the received streams, optionally by solving a set of over complete equations, as is known in the art.

In some embodiments of the invention, based on the reconstructed signal streams, the noise level on the link between transmitter 110 and receiver 112. Optionally, the noise level is determined by removing the effect of the reconstructed signal streams from one of the received streams (e.g., the stream not used in reconstructing the transmitted signal streams). Optionally, if the noise level is above a predetermined threshold, transmitter 110 is instructed to change the transmission frequency channel used.

JSCC decoder 668 decodes the reconstructed signal streams to extract their coarse portions, ignoring the refinement portions as if they were noise. Thereafter, the reconstructed signals are optionally filtered by spatial Winner filters, e.g., vector winner filters, to remove noise, and the refinement portions are extracted.

The decoded coarse signals are optionally decompressed by a video decompression unit 672 and the audio signals are decompressed by an audio decompression unit 674. The decompressed video signals are then added to the refinement portion signals in adders 688.

In some embodiments of the invention, a buffer 670 stores the decoded signals temporarily until they are decompressed. Buffers 670 and 212 (FIG. 2) optionally have a sufficient size to store the received data for a duration sufficient to request and receive retransmission of missing data. In an exemplary embodiment of the invention, the buffer size is equal to the size of data representing between 1-2 image lines multiplied by the round trip delay time of system 100, which data is between about 30-60 K.

An uplink path 680 is optionally used to request retransmission of data and/or to instruct transmitter 110 to change the frequency band on which it is transmitting, for example due to noise on the currently used frequency band. Optionally, when a high rate of errors is detected in the received data and/or the channel from transmitter 110 to receiver 112 is otherwise determined to be noisy, receiver 112 scans the other available bands to find a band suitable for transmission. In some embodiments of the invention, receiver 112 scans all the available bands to find a band or a plurality of sub-bands with a lowest noise level. Alternatively, receiver 112 scans the bands sequentially until a band with a noise level beneath a predetermined threshold is found. Receiver 112 then instructs transmitter 110, through uplink path 680 to transmit the data on the newly selected band.

In some embodiments of the invention, transmitter 110 periodically performs short recesses in the transmissions, in order to allow receiver 112 to determine the noise level of the currently used band, without the transmissions from transmitter 110 interfering with the transmission. Alternatively, receiver 112 determines the noise level while data is being transmitted by transmitter 110. In some embodiments of the invention, in accordance with this alternative, the noise is determined from the slice error, optionally by determining an increase in the power of the slice error. In other embodiments of the invention, the noise is determined after the received signals are cancelled from the transmitted data, based on the multiple number of antennas used for signal detection.

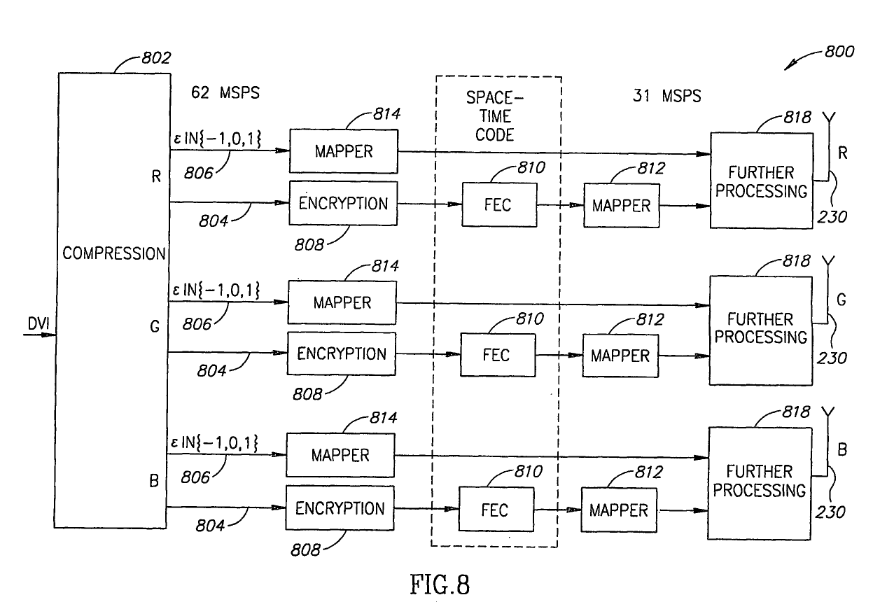

FIG. 8 is a block diagram of a transmitter 800, which may be used instead of transmitter 110 (FIG. 2), in accordance with an exemplary embodiment of the invention. In transmitter 800, each color component is handled separately such that the coarse portions of the color components are transmitted through separate antennas. Transmitter 800 includes three antennas 230, each of which corresponds to a color component of the image, e.g., R, G, B components. A compression unit 802 provides for each of the color components a coarse portion 804 and a refinement portion 806. In an exemplary embodiment of the invention, refinement portions 806 include, for each pixel, a correction value which may be either −1, 0 or 1. Optionally, coarse portion 804 of each color component includes an average data rate of 2.13 bits per pixel. Coarse portions 804 are optionally encrypted by encryption units 808 and are encoded by FEC units 810. Optionally, FEC units 810 use a relatively moderate 7/8 rate FEC. The encoded coarse portions 804 are mapped by mappers 812, for example using a 32 QAM mapping. Refinement portions 806 are mapped by mappers 814, for example using a 9 point QAM mapping. The mapped coarse and refinement portions are optionally passed for further processing 818, substantially as described above with reference to FIGS. 2 and 4. In an exemplary embodiment of the invention, antennas 230 transmit data at a rate of 31 Mega symbols per seconds.

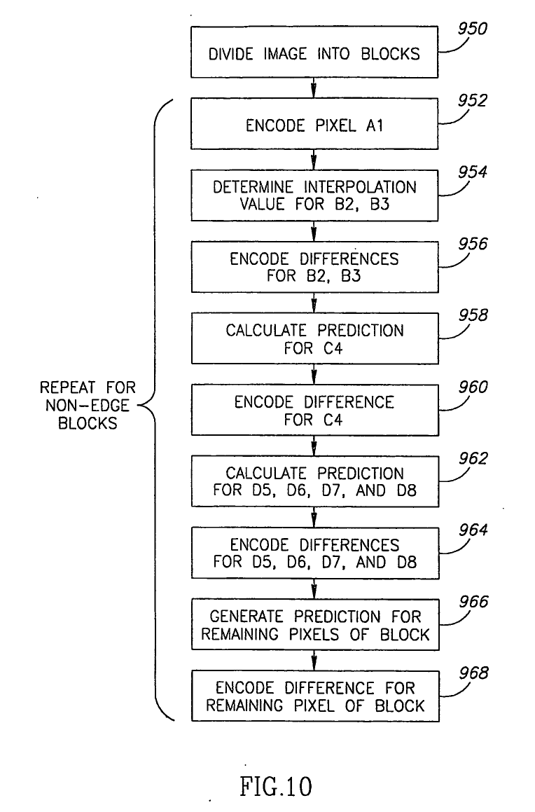

FIG. 9 is a schematic illustration of an order of compression of pixels of an image 900, in accordance with an exemplary embodiment of the invention. FIG. 10 is a flowchart of acts performed in compressing an image, in accordance with an exemplary embodiment of the invention.

The image is divided (950) into a plurality of equal size blocks (e.g., 4×8 pixel blocks). In FIG. 9, for simplicity, only blocks 902, 904, 906, 908 and 910 are shown. The left end and/or top edge blocks (e.g., 902, 904, 906 and 908) are encoded using any method known in the art. For each non-edge block (e.g., block 910), the lowest right pixel (marked as A1) of the. block 910 is encoded (952) in a first stage. In a second stage, an interpolated value for pixels B2 and B3 in the middle between pixel A1 and pixels R1 of blocks 904 and 908 are determined (954), based on the values of pixels A1 and R1. The difference between the actual values of pixels B2 and B3 and the interpolated values are then encoded (956). In a third stage, a prediction for pixel C4 is calculated (958) based on two or more of pixels B2, B3 and pixels R2 of blocks 904 and 908. The difference between the actual value of pixel C4 and its prediction value is encoded (960). In a fourth stage, predictions are generated (962) for pixels D5, D6, D7 and D8 based on the already encoded pixels of the current block and possibly values of the blocks 904 and 908. The difference between the actual values and the predictions are encoded (964).

In a fifth stage, predictions for the remaining pixels of block 910 are generated (966) and the pixels are encoded (968) based on the difference between the actual values and the predictions.

These stages are optionally repeated for all the blocks of the image. The blocks are optionally encoded in an order such that each block is encoded after the block above it and the block to its left were already encoded. If the blocks are encoded in a different direction, for example from right to left, the blocks are encoded accordingly.

In some embodiments of the invention, position markers are added periodically to the encoded image, for example every four lines, Thus, if alignment is lost due to noise, only a small part of the image is lost.

In some embodiments of the invention, the edge blocks are encoded using the same methods used for the non-edge blocks. Blocks that do not exist are optionally assigned a predetermined value, such as zero or an average image value.

The encoding of the difference between the pixel values and their predictions is optionally performed using a code book. In some embodiments of the invention, different code books are used for different contexts defined according to the position of the specific pixel in its block and/or according to the position of the block in the image. Alternatively or additionally, different contexts are defined according to the prediction value of the pixel.

Alternatively, any other encoding method is used, including stating the difference without changes.

The method of FIG. 10 allows compressing a plurality of blocks in parallel. Optionally, each image is divided into a predetermined number (e.g., 8, 16, 32) of vertical strips which are encoded separately. In some embodiments of the invention, each strip uses arbitrary values (e.g., zero) instead of values of previous strips, in order to allow completely independent compression of the strips. The resulting loss in compression efficiency is negligible, while the division allows parallel compression of the image, which makes the compression faster and simpler.

Alternatively or additionally, the predictions are performed partially in parallel and partially pipelined, while the encoding of the differences from the predictions are performed entirely in parallel.

The method of FIG. 10 thus allows simple parallel implementation of a compression method in the image domain, which achieves a compression ratio of above 50%.

In some embodiments of the invention, the difference between the actual value and the prediction is encoded in its entirety. Alternatively, the encoding represents the difference up to a predetermined error level.

Optionally, the coarse portion includes the encoding of all the pixels, while the refinement portion includes the difference between results of the encoding and the actual image due to the allowed error level. Optionally, some of the pixels, used for estimating many other pixels (e.g., A1, B2 and B3), are encoded without error. Hence, refinement portion values for these pixels are not required.

Alternatively, the coarse portion includes values for some of the pixels, while the values of some of the pixels are transmitted in their entirety in the refinement portion. Further alternatively or additionally, a non-linear division between the coarse and refinement portions, is used. For example, a logarithmic representation of the pixel values may be used.

In some embodiments of the invention, the compressed image is transmitted in three portions: a coarse portion, a first correction portion and a second correction portion. Optionally, the coarse portion includes the encoded values of some of the pixels (e.g., A1, B2, B3, C4, D5, D6, D7 and D8), while the values of the remaining pixels are included in the first correction portion, with an accuracy up to the maximal allowed error level. The second correction portion represents the remaining data to compensate to errors within the allowed maximal error level.

The first correction portion is optionally transmitted using the same constellation as the coarse portion but with a weaker FEC protection. Alternatively, three constellations are defined for the coarse portion and the two correction portions. The constellation of the first correction portion has a total side to side amplitude, which does not interfere with the decoding of the coarse portion. Similarly, the constellation of the second correction portion has a total side to side amplitude, which does not interfere with the decoding of the first correction portion.

The use of interpolation predictions that are based on non-neighboring base values, as in the exemplary embodiment of FIG. 10, provides, on the average, better compression than other methods. It is noted that the order of pixel encoding in FIG. 10 and/or the specific pixels encoded in each stage are presented as an example, and many other pixel orders may be used in accordance with the present invention. Furthermore, blocks of other block sizes may be used in accordance with the present invention. Various implementation possibilities of the method of FIG. 10 are described in a U.S. provisional patent application 60/590,197 titled “Interpolation Image Compression”, filed Jul. 21, 2004.

As described above, in some embodiments of the invention, a MIMO link is used to convey multi-resolution signals. In other embodiments of the invention, a MIMO link is used to convey analog signals, without generalization. For example, a television analog signal is split into a plurality (e.g., 4-5) sub-bands. All the sub-bands are translated onto a single frequency band for transmission. In some embodiments of the invention, the synchronization signals of the television analog signal are included in only a single sub-band, in order to prevent synchronization loss between the sub-bands.

In another embodiment of the invention, analog radio signals are transmitted using analog MIMO. The use of analog MIMO can be used to increase the number of channels which can be used in the frequency band designated for radio transmission.

Although the above description relates to transmission of video images, the principles of the present invention may be used for other data, for which reception of less than the entire content is of value (i.e., data loss is acceptable but not desirable). For example, the principles of the present invention may be used to transmit audio files and/or still images. In an exemplary embodiment of the invention, the principles of the-present invention are used to transfer documents of a word processor. The documents are organized in a form of critical data (e.g., the content of the document) and non-critical data (e.g., formatting of the word processor tool, formatting of the text). Optionally, the receiver determines which data was lost and notifies the user on the lost data. In some embodiments of the invention, the user may select whether to be notified on the data that was lost, or not.

It is noted that although the above description relates to local wireless transmission, the principles of the invention may be used in other noisy environments, such as multiple wires with cross-talk and/or cellular wireless links.

Although in the above description the entire video representation is transmitted to the receiver without any data loss, in some embodiments of the invention, refinement portion 208 does not correct all discrepancies between coarse portion 206 and the original data. For example, the maximal discrepancy may have a value up to ±3, while only discrepancies of ±2 are transmitted. In another exemplary embodiment of the invention, only discrepancies of up to ±1 are transmitted.

It will be appreciated that the above described methods and apparatus may be varied in many ways, including changing the exact implementation used for the apparatus. It should also be appreciated that the above described methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. For example, the video images may be low definition or high definition video images of various formats. In some embodiments of the invention, the methods of the present invention (e.g., one or more of the compression method of FIG. 10, the use of image domain compression and the division into coarse and refinement portions) are applied to images including at least 45, 48, 60 or even more frames per second. Alternatively or additionally, the methods are applied to video streams having an uncompressed data rate of above 100, 300, 500, 600 or even 900 Mbits per second. Heretoforth, for such high data rates very strong compression methods, which require high complexity, were generally used. In an exemplary embodiment of the invention, the methods of the invention are applied to streams that have an uncompressed data rate of above 1.2 Gbits per second or even above 1.4 Gbits per second.

It should be understood that features and/or steps described with respect to one embodiment may be used with other embodiments and that not all embodiments of the invention have all of the features and/or steps shown in a particular figure or described with respect to one of the embodiments. For example, the method of FIG. 10 may be used for substantially any application that requires image compression. In some embodiments of the invention, the compression method of FIG. 10 is used for transmission from transmitter 110 to receiver 112.

In some embodiments of the invention, an image domain compression for wireless transmission is used, without dividing the resultant compressed video representation into coarse and refinement portions. The use of image domain compression is less sensitive to transient noise and fading.

Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of transmitting video images, comprising:
providing a high definition video stream;
compressing the video stream using an image domain compression method, in which each pixel is coded based on a vicinity of the pixel; and
transmitting the compressed video stream over a fading transmission channel.

2. A method according to claim 1, wherein providing the high definition video stream comprises providing a stream including at least 45 frames per second.

3. A method according to claim 1, wherein providing the high definition video stream comprises providing a stream having an uncompressed data rate of above 100 Mbit per second.

4. A method according to claim 1, wherein providing the high definition video stream comprises providing a stream having an uncompressed data rate of above 0.6 Gbits per second.

5. A method according to claim 1, wherein compressing the video stream comprises compressing without substantial interdependence between frames.

6. A method according to claim 1, wherein compressing the video stream comprises compressing such that the value of each pixel depends directly on no more than 50 neighboring pixels.

7. A method according to claim 1, wherein compressing the video stream comprises compressing such that the value of at least some of the pixels depends on non-adjacent pixel values.

8. A method according to claim 1, wherein compressing the video stream comprises compressing at least some of the pixels without relation to values of any other pixels.

9. A method according to claim 1, wherein transmitting the compressed stream comprises transmitting on a wireless link.

10. A method according to claim 1, wherein transmitting the compressed stream comprises transmitting using a joint source and channel encoding method.

11. A method according to claim 1, wherein compressing the video stream comprises compressing such that each pixel is coded based on a vicinity of the pixel having a diameter smaller than 20 pixels.

12. A method of transmitting video images, comprising:
providing a video image;
compressing the video image into a coarse portion, which has, for at least one color component, a bounded difference from the provided image, for a predetermined set of the pixels of the image;
representing the difference between the coarse portion and the video image by a refinement portion;
mapping the coarse portion and at least part of the refinement portion into symbols of a constellation; and
transmitting the mapped symbols to a receiver.

13. A method according to claim 12, wherein compressing the video image comprises compressing such that the difference between the coarse portion and the provided image is bounded for substantially all the pixels of the image.

14. A method according to claim 12, wherein compressing the video image comprises compressing such that the difference between the coarse portion and the provided image is bounded to have at most ten different possible values.

15. A method according to claim 12, wherein compressing the video image comprises compressing such that the difference between the coarse portion and the provided image is bounded to have at most five different possible values.

16. A method according to claim 12, wherein the difference between the coarse portion and the provided image is bounded by a maximal value which is less than 5% of the possible values of the provided images.

17. A method according to claim 12, wherein compressing the video image comprises compressing such that the difference between the coarse portion and the provided image is bounded for substantially all the color components representing the image.

18. A method according to claim 12, wherein mapping the portions comprises mapping the coarse and refinement portions separately into symbols and superimposing the symbols onto each other.

19. A method according to claim 18, wherein mapping the portions comprises mapping the refinement portion into symbols of a constellation having a side to side distance smaller than the distance between the symbols of a constellation of the symbols of the coarse portion.

20. A method according to claim 12, wherein the coarse portion is protected by a forward error correction code, while the refinement portion is transmitted without protection by a forward error correction code.

21. A method according to claim 12, wherein the refinement portion is mapped uncoded into symbols.

22. A method according to claim 12, wherein mapping the portions comprises mapping the refinement portion into a constellation having a discrete number of possible values.

23. A method according to claim 12, wherein transmitting the mapped symbols comprises transmitting over a multi-input multi-output MIMO link.

24. A method according to claim 12, wherein representing the difference between the coarse portion and the video image by a refinement portion formed of a plurality of refinement sub-portions, each of which has a smaller side to side constellation size.

25. A method according to claim 12, wherein the coarse and refinement portions together represent the video image in a non-compressed standard representation of color video with at most slight filtering.

26. A method of transmitting video images, comprising:
providing a video image;
compressing the video image into a coarse portion;
representing a difference between the coarse portion and the video image by a refinement portion;
mapping the coarse portion and at least part of the refinement portion into symbols of a constellation, wherein the refinement portion is mapped uncompressed; and
transmitting the mapped symbols to a receiver.

27. A method according to claim 26, wherein compressing the video image comprises compressing such that the difference between the coarse portion and the provided image is bounded for substantially all the pixels of the image.

28. A method according to claim 26, wherein mapping the portions comprises mapping the coarse and refinement portions separately into symbols and superimposing the symbols onto each other.

29. A method according to claim 28, wherein mapping the portions comprises mapping the refinement portion into symbols of a constellation having a side to side distance smaller than the distance between the symbols of a constellation of the symbols of the coarse portion.

30. A method according to claim 26, wherein transmitting the mapped symbols comprises transmitting over a multi-input multi-output MIMO link.

31. A method according to claim 26, wherein representing the difference by a refinement portion comprises determining for each pixel a difference between the coarse portion and the provided image and wherein each value of the refinement portion is related to at most 100 pixels of the image.

32. A method according to claim 26, wherein representing the difference by a refinement portion comprises determining for each pixel a difference between the coarse portion and the provided image and wherein each value of the refinement portion is related to at most 10 pixels of the image.

33. A method according to claim 26, wherein representing the difference by a refinement portion comprises determining for each pixel a difference between the coarse portion and the provided image and wherein each value of the refinement portion represents a difference between the coarse portion and the provided image at a point on the image.

34. A method according to claim 33, wherein each value of the refinement portion represents a difference between the coarse portion and the provided image at a point on the image coinciding with a pixel.

35. A method according to claim 33, wherein at least one value of the refinement portion represents a difference between the coarse portion and the provided image at a point on the image interpolated for two or more neighboring pixels.

36. A method according to claim 26, wherein mapping the portions comprises mapping the refinement portion into symbols of a constellation having a bin for each of the possible values of the difference between the coarse portion and the provided image for a specific point on the image.

37. A method according to claim 26, wherein the refinement portion is mapped uncoded.

38. A method according to claim 26, wherein the refinement portion is mapped without undergoing a transform into a non-image domain.

39. A method according to claim 26, wherein the coarse portion is protected by a forward error correction code, while the refinement portion is transmitted without protection by a forward error correction code.

40. A method according to claim 26, wherein mapping the portions comprises mapping the refinement portion into a constellation having a discrete number of possible values.

41. A method according to claim 26, wherein mapping the portions comprises mapping the refinement portion into a constellation such that its value degrades gracefully with noise.

42. A method of transmitting video images, comprising:
providing a video image;
compressing the video image into a coarse portion, having a first average number of bits per pixel;
representing the difference between the coarse portion and the video image by a refinement portion, having an average equivalent bit rate requiring a greater number of bits per pixel, for representation, than the first average number;
mapping the coarse and refinement portions into symbols of a constellation; and
transmitting the mapped symbols to a receiver.

43. A method according to claim 42, wherein the refinement portion is not represented by bits.

44. A method according to claim 42, wherein the refinement portion has a predetermined number of values for each symbol.

45. A method according to claim 42, wherein compressing the video image comprises compressing such that the difference between the coarse portion and the provided image is bounded to have at most ten different possible values.

46. A method according to claim 42, wherein mapping the portions comprises mapping the coarse and refinement portions separately into symbols and superimposing the symbols onto each other.

47. A method according to claim 42, wherein representing the difference by a refinement portion comprises determining for each pixel a difference between the coarse portion and the provided image and wherein each value of the refinement portion is related to at most 10 pixels of the image.

48. A method according to claim 42, wherein the coarse portion is protected by a forward error correction code, while the refinement portion is transmitted without protection by a forward error correction code.

49. A method according to claim 42, wherein the average equivalent bit rate of the refinement portion requires for representation at least twice the number of bits from the first average number.

50. A method of transmitting video images, comprising:
providing a video image;
compressing the video image into a coarse portion, using a near lossless compression method achieving less than a 15:1 compression ratio;
representing the difference between the coarse portion and the video image by a refinement portion;
mapping the coarse and refinement portions into symbols of a constellation; and
transmitting the mapped symbols to a receiver.

51. A method according to claim 50, wherein mapping the portions comprises mapping the coarse and refinement portions separately into symbols and superimposing the symbols onto each other.

52. A method according to claim 51, wherein mapping the portions comprises mapping the refinement portion into symbols of a constellation having a side to side distance smaller than the distance between the symbols of a constellation of the symbols of the coarse portion.

53. A method according to claim 50, wherein compressing the video image comprises compressing with a compression ratio of less than 8:1.

54. A method according to claim 50, wherein compressing the video image comprises compressing with a compression ratio of less than 12:1.

55. A method of transmitting data, comprising:
generating a plurality of streams at least partially carrying data which gracefully degrades with noise;
transmitting the plurality of streams in parallel through a MIMO transmitter; and
receiving the plurality of streams by a MIMO receiver.

56. A method according to claim 55, comprising decoding the plurality of symbol streams by the MIMO receiver.

57. A method according to claim 56, wherein the MIMO receiver uses a spatial Winner filter to decode the streams.

58. A method according to claim 55, wherein the streams include analog streams.

59. A method according to claim 55, wherein the streams include symbol streams that at least partially have a representation of data along a continuous analog range.

60. A method according to claim 55, wherein the streams include symbol streams that at least partially are selected from a constellation in which closer bins have closer values.

61. A method according to claim 55, wherein the streams include symbol streams that represent an overlap of coarse and refinement portions.

62. A method of receiving data, comprising:
receiving transmitted MIMO signals using a plurality of antennas including at least one antenna more than used in transmitting the signals;
determining from the signal of at least one of the receiver antennas a noise level of a link on which the signals are received; and
instructing the transmitter to change a transmission parameter responsive to a determination that the noise level is above an allowed level.

63. A method according to claim 62, comprising decoding the signals using the received signals.
